(19) United States
(12) Patent Application Publication
(10) Pub. No.: US 2026/0046529 A1
(43) Pub. Date: Feb. 12, 2026

(54) IMAGE PICKUP APPARATUS CAPABLE OF NOTIFYING USER OF PHOTOGRAPHING METHOD IN WHICH FLICKERLESS PHOTOGRAPHING IS EFFECTIVE, CONTROL METHOD FOR IMAGE PICKUP APPARATUS, AND STORAGE MEDIUM

(71) Applicant: CANON KABUSHIKI KAISHA, Tokyo (JP)

(72) Inventor: HINAKO NAKAMURA, Kanagawa (JP)

(21) Appl. No.: 19/263,951

(22) Filed: Jul. 9, 2025

(30) Foreign Application Priority Data
Aug. 8, 2024 (JP) 2024-131924

(51) Int. Cl. H04N 23/745; H04N 23/60; H04N 23/76

(52) U.S. Cl. CPC H04N 23/745; H04N 23/64; H04N 23/76

(57) ABSTRACT

An image pickup apparatus capable of notifying a user of a photographing method in which the flickerless photographing is effective is provided. The image pickup apparatus includes an image pickup unit configured to pick up an image of a subject and obtain image signals, and at least one processor and/or circuit configured to function as a detecting unit that detects light source information of a light source at a time of image pickup from the image signals, a selecting unit that, in a case where the light source at the time of image pickup is a flickering light source, selects an effective reduction processing method for reducing an influence of the flickering light source from among a plurality of flicker reduction processing methods based on the detected light source information, and a notifying unit that notifies a user of the selected reduction processing method.

### BACKGROUND

### Field of the Technology

The present disclosure relates to an image pickup apparatus, a control method for the image pickup apparatus, and a storage medium, and more particularly to an image pickup apparatus that performs flickerless photographing, a control method for the image pickup apparatus, and a storage medium.

### Description of the Related Art

When performing photographing of a still image or a moving image under a flickering light source, the influence of flicker may appear in the still image or the moving image as luminance unevenness or stripes. Conventionally, several photographing methods for performing photographing that reduces the influence of flicker (hereafter, referred to as “flickerless photographing”) have been known. Japanese Laid-Open Patent Publication (kokai) No. 2016-58844 has proposed a photographing method for detecting flicker and performing photographing at a photographing timing that is less affected by the detected flicker. In addition, Japanese Laid-Open Patent Publication (kokai) No. 2022-129925 has proposed a photographing method in which an accumulation time is set to an integer multiple of a flicker period. Moreover, Japanese Laid-Open Patent Publication (kokai) No. 2009-17213 has proposed a photographing method for performing detection and correction of line flicker that is caused by a slit rolling shutter during photographing.

However, while the photographing method disclosed in Japanese Laid-Open Patent Publication (kokai) No. 2016-58844 is capable of photographing an image in which the influence of the flicker has been reduced, there will be a release time lag that corresponds to the photographing timing. For this reason, a camera needs to notify a user by using an icon or the like that the camera is in a flicker environment and the flickerless photographing is to be performed, and the user needs to perform photographing only after understanding that functions to be restricted occur.

The photographing method disclosed in Japanese Laid-Open Patent Publication (kokai) No. 2022-129925 and the photographing method disclosed in Japanese Laid-Open Patent Publication (kokai) No. 2009-17213 also result in the occurrence of functions to be restricted. For example, in the case of using the photographing method disclosed in Japanese Laid-Open Patent Publication (kokai) No. 2022-129925, the accumulation time must be set to an integer multiple of the flicker period, while in the case of using the photographing method disclosed in Japanese Laid-Open Patent Publication (kokai) No. 2009-17213, it will be affected by noises due to an image correction gain.

For this reason, it is desirable to select a photographing method, in which the flickerless photographing is effective, depending on the photographing environment and scene, but it is difficult to get the user to make such a selection properly.

### SUMMARY

The present disclosure provides an image pickup apparatus capable of notifying a user of a photographing method in which the flickerless photographing is effective, a control method for the image pickup apparatus, and a storage medium.

Accordingly, an aspect of the present disclosure provides an image pickup apparatus comprising an image pickup unit configured to pick up an image of a subject and obtain image signals, and at least one processor and/or circuit configured to function as a detecting unit that detects light source information of a light source at a time of image pickup from the image signals, a selecting unit that, in a case where the light source at the time of image pickup is a flickering light source, selects an effective reduction processing method for reducing an influence of the flickering light source from among a plurality of flicker reduction processing methods based on the detected light source information, and a notifying unit that notifies a user of the selected reduction processing method.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a hardware configuration of a digital camera as an image pickup apparatus according to the present disclosure.

FIG. 2A is a conceptual diagram for explaining a flicker reduction processing method based on photographing timing.

FIG. 2B is a conceptual diagram for explaining a flicker reduction processing method based on accumulation time.

FIG. 2C is a conceptual diagram for explaining a flicker reduction processing method based on image correction gain.

FIG. 3 is a flowchart that illustrates the flow of an entire processing according to a first embodiment of the present disclosure.

FIG. 4A is a flowchart of a processing for determining the effectiveness of the flicker reduction processing method based on photographing timing, which is performed in a step S103 shown in FIG. 3.

FIG. 4B is a flowchart of a processing for determining the effectiveness of the flicker reduction processing method based on accumulation time, which is performed in a step S104 shown in FIG. 3.

FIG. 4C is a flowchart of a processing for determining the effectiveness of the flicker reduction processing method based on image correction gain, which is performed in a step S105 shown in FIG. 3.

FIG. 5A is a flowchart of a notification control processing performed in a step S106 shown in FIG. 3 according to the first embodiment of the present disclosure.

FIG. 5B is a flowchart of a reduction method priority determination processing performed in a step S304 shown in FIG. 5A.

FIG. 6 is a conceptual diagram that illustrates an example of icon display performed by a flicker notifying unit in a step S303 shown in FIG. 5A.

FIG. 7 is a flowchart of the notification control processing performed in the step S106 shown in FIG. 3 according to a second embodiment of the present disclosure.

FIG. 8 is a conceptual diagram that illustrates an example of icon display performed by the flicker notifying unit in a step S406 shown in FIG. 7.

### DESCRIPTION OF THE EMBODIMENTS

The present disclosure will now be described in detail below with reference to the accompanying drawings showing embodiments thereof.

Hereinafter, embodiments will be described in detail with reference to the accompanying drawings. It should be noted that the following embodiments do not limit the invention as defined by the claims. Although the embodiments describe a plurality of features, not all of the plurality of features are essential to the present disclosure, and the plurality of features may be combined in any desired manner. Furthermore, in the accompanying drawings, the same reference numbers are used for the same or similar components, and duplicate descriptions will be omitted.

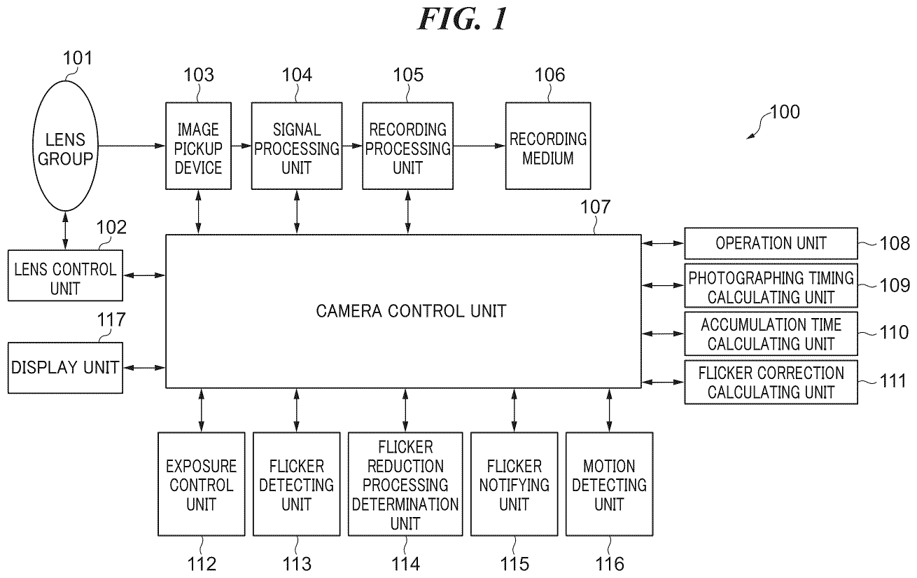

Hereinafter, a digital camera 100 (hereinafter, simply referred to as “a camera 100”) as an image pickup apparatus according to an embodiment of the present disclosure will be described with reference to FIG. 1.

FIG. 1 is a block diagram that illustrates a hardware configuration of the camera 100.

As shown in FIG. 1, the camera 100 includes a lens group 101, a lens control unit 102, an image pickup device (an image sensor) 103, a signal processing unit 104, a recording processing unit 105, a recording medium 106, a camera control unit 107, an operation unit 108, a photographing timing calculating unit 109, and an accumulation time calculating unit 110. Furthermore, the camera 100 includes a flicker correction calculating unit 111, an exposure control unit 112, a flicker detecting unit 113, a flicker reduction processing determination unit 114, a flicker notifying unit 115, a motion detecting unit 116, and a display unit 117.

The lens group 101 includes a mechanism for controlling exposure by a diaphragm and a mechanism for controlling focus and zoom operations, and focuses incident light onto the image pickup device 103 (an image pickup unit) to form an optical image.

The image pickup device 103 converts the formed optical image into electrical signals and outputs the electrical signals to the signal processing unit 104. At this time, the lens group 101 drives the diaphragm to control an accumulation time in the image pickup device 103 and an amplification rate of the electrical signals. As a result, the exposure of an image picked up (a picked-up image) is controlled.

The signal processing unit 104 performs gain correction such as luminance correction and/or flicker correction, color correction such as white balance, and other signal processing with respect to image signals obtained from the image pickup device 103, and outputs the image signals to the recording processing unit 105 and the display unit 117. It should be noted that the flicker correction is a means for performing correction based on light source information of a flickering light source detected by the flicker detecting unit 113, and will be described in detail below.

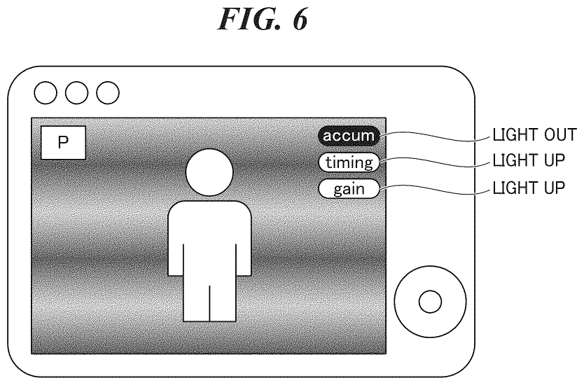

The display unit 117 includes a liquid crystal screen provided on the rear surface of the main body of the camera 100, and performs icon display shown in FIG. 6 that will be described below, and displays, as an image, the image signals outputted from the signal processing unit 104.

The recording processing unit 105 converts the image signals outputted from the signal processing unit 104 into image signals in a format recordable by the recording medium 106, outputs, to the recording medium 106, the image signals in the format recordable by the recording medium 106, and causes the image signals in the format recordable by the recording medium 106 to be recorded in a recording medium of the recording medium 106.

The camera control unit 107 includes a central processing unit (a CPU), a read only memory (a ROM), and a random access memory (a RAM), all of which are not shown in FIG. 1, that are built therein, and the CPU loads a program stored in the ROM into the RAM and executes it, thereby controlling the entire camera 100. The camera control unit 107 functions as a controller that controls the flow of a series of image processes executed by the camera 100, and each of the other blocks shown in FIG. 1 is connected to the camera control unit 107. The camera control unit 107 accepts operations from a user via the operation unit 108, and calculates settings related to zoom, focus, and brightness of a photographed image in accordance with a set photographing mode and brightness of a subject.

In addition, the camera control unit 107 transmits the calculated settings to the lens control unit 102 and the exposure control unit 112, and controls each component to a control position and a control state in accordance with the setting value.

The flicker detecting unit 113 (a detecting unit) receives, as input, the electrical signals of the optical image (the picked-up image) accumulated in the image pickup device 103, and in the case where a light source at the time of image pickup is a flickering light source based on the periodicity of a luminance change between previous and next images, detects light source information such as a frequency, a phase, and a waveform of a change in brightness of the flickering light source.

The photographing timing calculating unit 109 (a timing calculating unit) decides a timing for executing photographing based on the frequency and the phase of the flicker detected by the flicker detecting unit 113 and notifies the camera control unit 107 of the decided timing. The camera control unit 107 executes photographing based on the timing notified by the photographing timing calculating unit 109.

The accumulation time calculating unit 110 (an accumulation time calculating unit) calculates an accumulation time that is N times the frequency of the flicker detected by the flicker detecting unit 113, and notifies the camera control unit 107 of the calculated accumulation time. The camera control unit 107 transmits the accumulation time notified by the accumulation time calculating unit 110 to the exposure control unit 112 and executes photographing.

The flicker correction calculating unit 111 (a correction calculating unit) calculates an amount of correction for the in-plane luminance unevenness of the flicker detected by the flicker detecting unit 113, and notifies the signal processing unit 104 of the amount of correction. The signal processing unit 104 performs the gain correction with respect to the photographed image based on the calculation result from the flicker correction calculating unit 111 so as to reduce exposure unevenness due to the flicker.

In the case where the flicker has been detected by the flicker detecting unit 113, the flicker reduction processing determination unit 114 (a selecting unit) selects at least one of flicker reduction processing means (flicker reduction processing methods), which will be described below, based on information about the detected flicker and photographing conditions set by the operation unit 108.

The selected flicker reduction processing means (the selected flicker reduction processing method) is notified by the flicker notifying unit 115 (a notifying unit). For example, the flicker notifying unit 115 notifies the selected flicker reduction processing means (the selected flicker reduction processing method) by icon display displayed on the display unit 117, which is shown in FIG. 6 and will be described below.

It should be noted that the photographing timing calculating unit 109, the accumulation time calculating unit 110, the flicker correction calculating unit 111, the exposure control unit 112, the flicker detecting unit 113, and the flicker reduction processing determination unit 114 may be configured to be included in the camera control unit 107.

The motion detecting unit 116 includes a sensor such as a gyro sensor (not shown), and detects an attitude and a motion (an angle, an acceleration, an amount of movement, etc.) of the main body of the camera 100 based on output results of the sensor. In addition, the motion detecting unit 116 may detect a motion vector of a feature point in the photographed image as the motion of the main body of the camera 100.

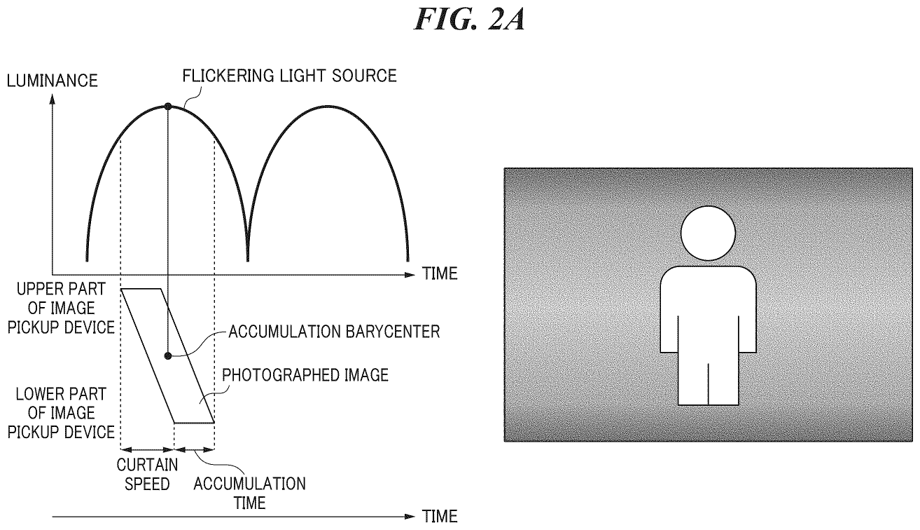

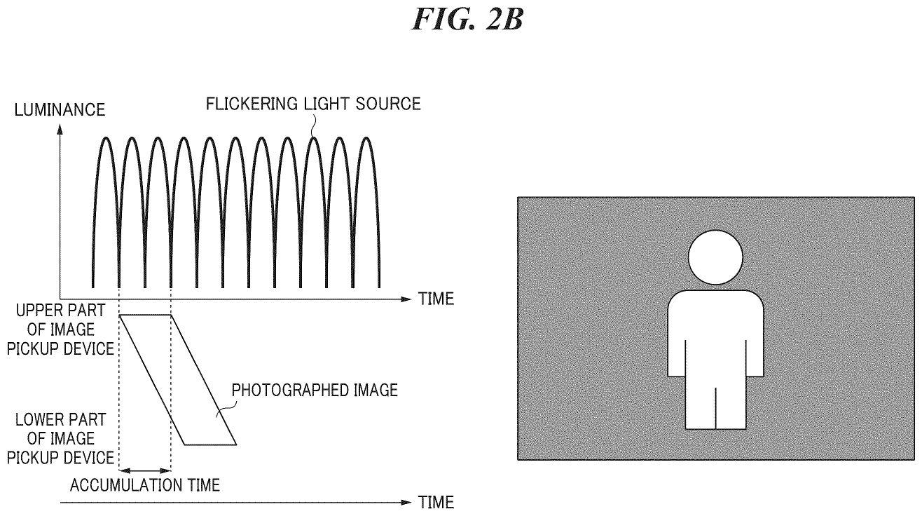

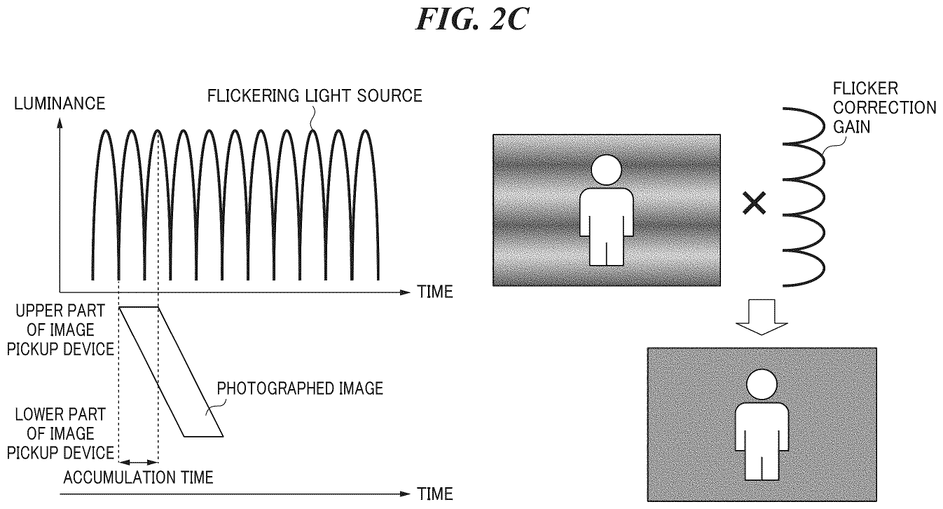

Hereinafter, with reference to FIG. 2A, FIG. 2B, and FIG. 2C, three flicker reduction processing means (three flicker reduction processing methods) according to the present disclosure for reducing the influence of a flickering light source when performing the flickerless photographing will be described.

FIG. 2A is a conceptual diagram for explaining a flicker reduction processing means based on photographing timing (a flicker reduction processing method based on photographing timing).

In the flicker reduction processing method based on photographing timing shown in FIG. 2A, a frequency and a phase of the flickering light source that is occurring are detected, and a photographing timing is set to a timing that is less affected by the flicker.

Specifically, image pickup control is performed so that a timing at which a shutter travels from the upper part of the image pickup device 103 to the lower part of the image pickup device 103 coincides with a timing at which the flickering light source is at its brightest. This makes it possible to photograph an image in which the central part of the screen becomes the brightest and the luminance gradually decreases from the central part to the upper part and the lower part of the screen.

FIG. 2B is a conceptual diagram for explaining a flicker reduction processing means based on accumulation time (a flicker reduction processing method based on accumulation time).

In the flicker reduction processing method based on accumulation time shown in FIG. 2B, by adjusting the accumulation time with respect to the flickering light source that is occurring, photographing is performed without being affected by the flicker.

For example, by performing photographing with an accumulation time that is an integer multiple of one cycle time of the flickering light source that is occurring (a flicker period), all pixels from the upper part of the image pickup device 103 to the lower part of the image pickup device 103 are capable of being accumulated with the same exposure amount, thereby reducing the influence of the flicker.

FIG. 2C is a conceptual diagram for explaining a flicker reduction processing means based on image correction gain (a flicker reduction processing method based on image correction gain).

In the flicker reduction processing method based on image correction gain shown in FIG. 2C, a flicker component of the flickering light source is extracted and the influence of the flicker is reduced by applying a correction gain after photographing.

For example, the flicker component is capable of being extracted by comparing an image generated by applying a circular low-pass filter with an image in which flicker appears, and a flicker correction gain value is capable of being calculated by taking a reciprocal of the extracted flicker component. By setting the flicker correction gain value (a correction value) in the signal processing unit 104, an image, in which the influence of the flicker has been reduced, is capable of being generated.

It should be noted that the type of the shutter is not particularly limited, and the shutter may be a slit rolling shutter as in the present embodiment, or a global shutter. However, while a slit rolling shutter is limited to a flicker frequency that is a low frequency equal to or lower than a curtain speed, a global shutter has no limit to a supported frequency range. For this reason, in the case of the slit rolling shutter, depending on the flicker frequency, it is not possible to effectively use the flicker reduction processing method based on photographing timing shown in FIG. 2A. In addition, in the case where the flickering light source has a special waveform other than a parabolic waveform shown in FIG. 2A, the slit rolling shutter is not able to handle this case, but the global shutter is able to handle this case. For this reason, in the case of the slit rolling shutter, depending on the waveform of the flickering light source, it is not possible to use the flicker reduction processing method based on photographing timing shown in FIG. 2A. In addition, in the case of the flicker reduction processing method based on accumulation time shown in FIG. 2B, as described above, in the slit rolling shutter, the accumulation time must be an integer multiple of the period of the flicker that is occurring. On the other hand, with the global shutter, there is no limit to the accumulation time, but it is necessary to increase the gain to reduce uneven shutter release.

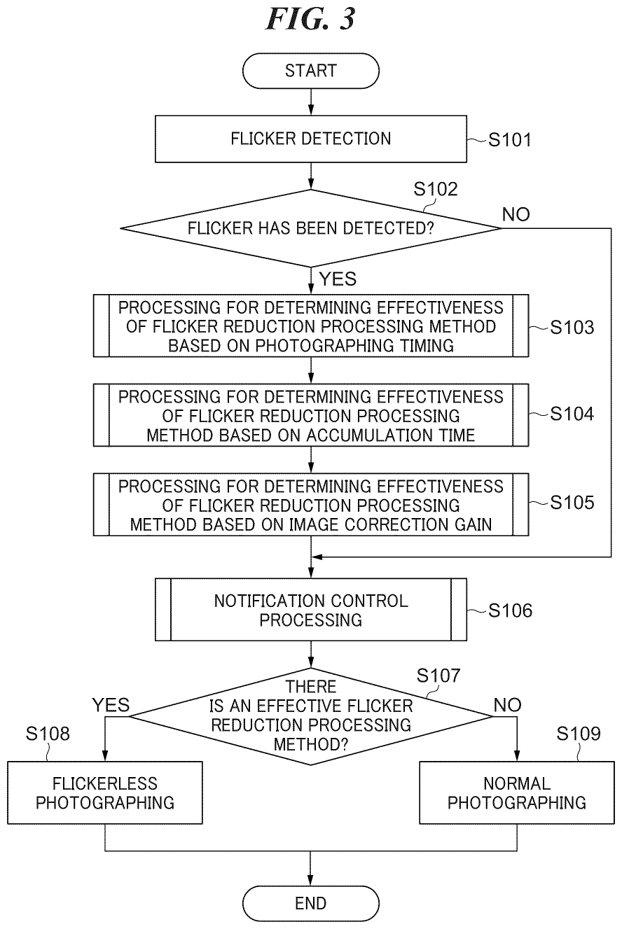

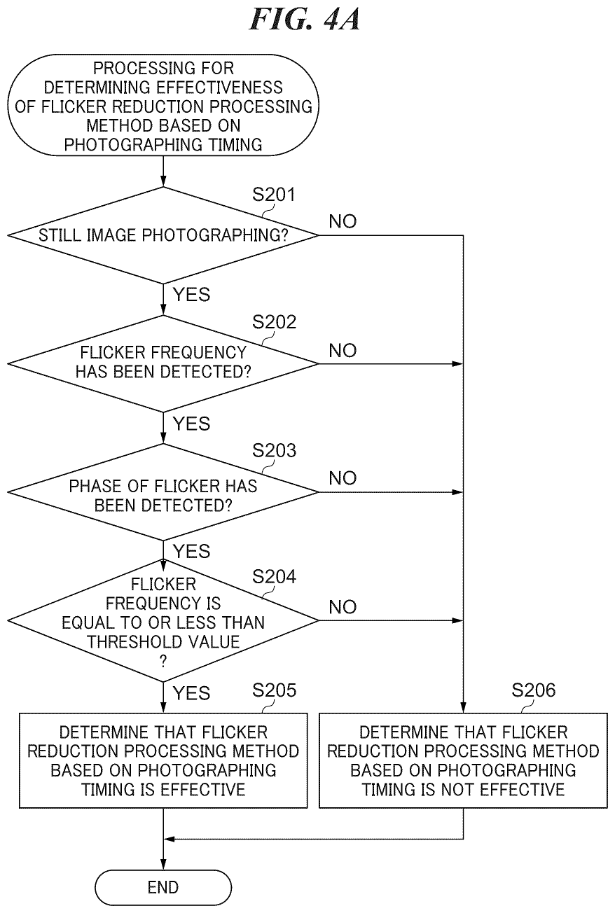

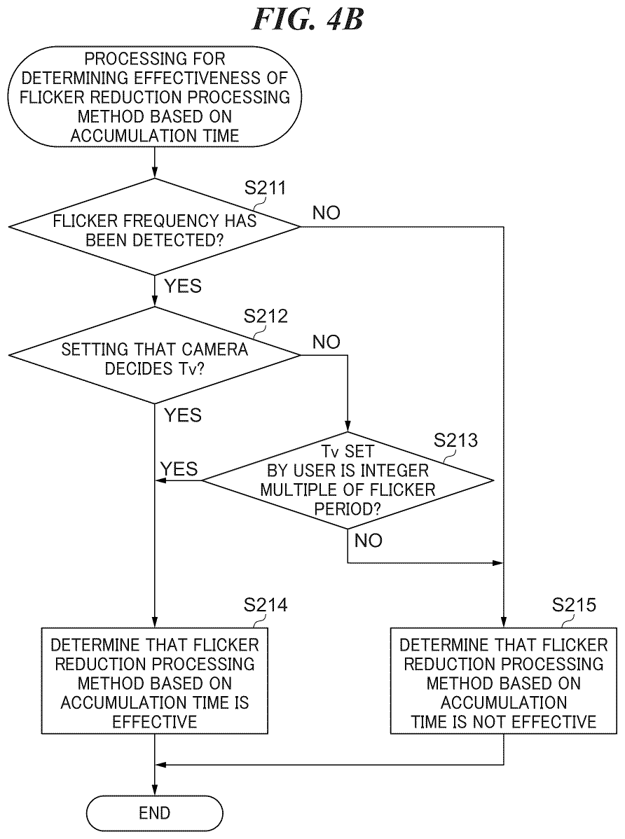

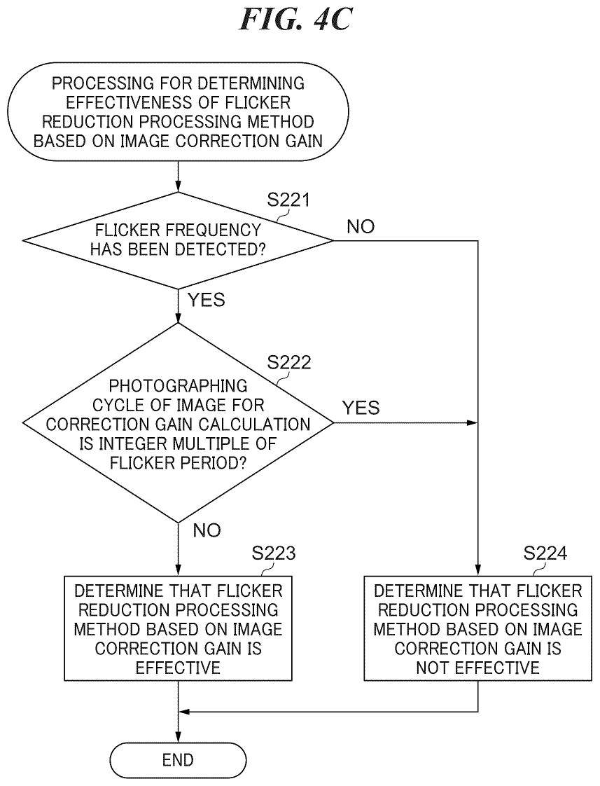

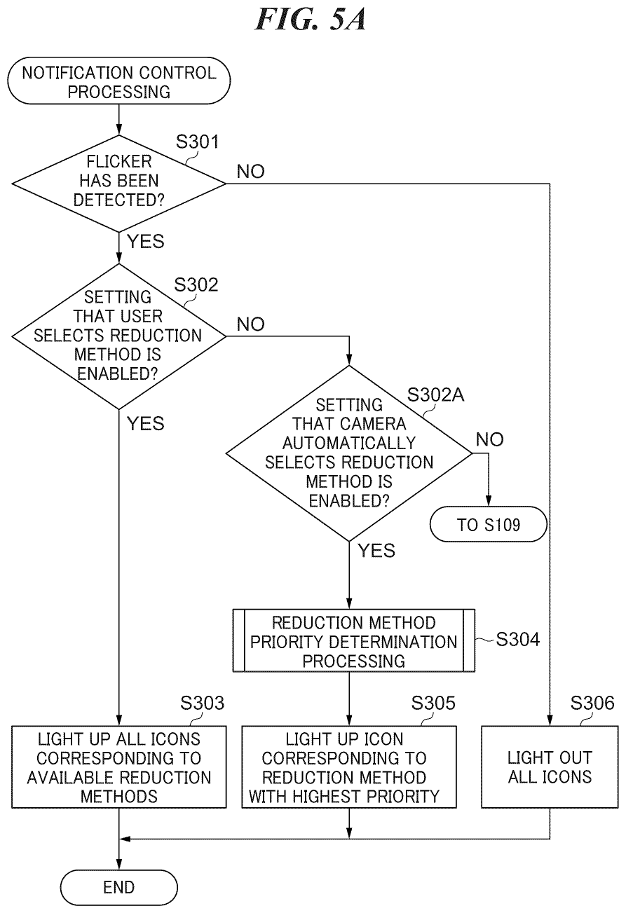

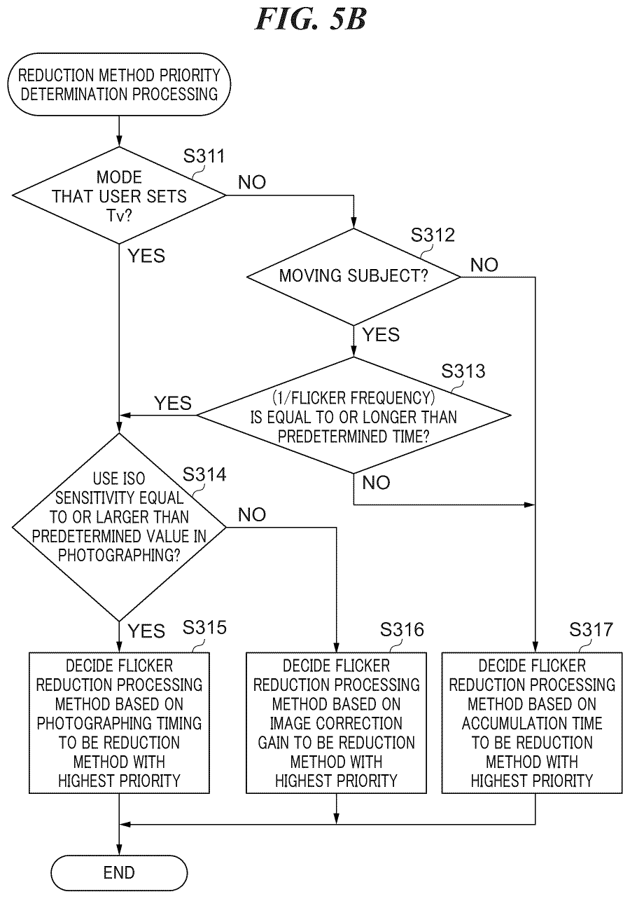

A first embodiment will be described. The flow of an entire processing according to the first embodiment will be described below with reference to a flowchart of FIG. 3. In addition, a processing for determining the effectiveness of the flicker reduction processing method based on photographing timing shown in FIG. 2A will be described with reference to a flowchart of FIG. 4A. Furthermore, a processing for determining the effectiveness of the flicker reduction processing method based on accumulation time shown in FIG. 2B will be described with reference to a flowchart of FIG. 4B. Moreover, a processing for determining the effectiveness of the flicker reduction processing method based on image correction gain shown in FIG. 2C will be described with reference to a flowchart of FIG. 4C. In addition, a notification control processing performed in a step S106 shown in FIG. 3 will be described with reference to a flowchart of FIG. 5A and a flowchart of FIG. 5B, and a display example based on the notification control processing will be described with reference to FIG. 6.

FIG. 3 is the flowchart that illustrates the flow of the entire processing according to the first embodiment. Specifically, the entire processing is executed by the CPU built into the camera control unit 107 loading a program stored in the ROM into the RAM, but hereinafter, the main entity executing the entire processing will simply be the camera control unit 107.

As shown in FIG. 3, in a step S101, the flicker detecting unit 113 performs detection of the flicker that is occurring, and the entire processing proceeds to a step S102.

In the step S102, it is determined whether or not flicker has been detected. In the case of being determined that flicker has not been detected (NO in the step S102), the entire processing proceeds to the step S106 (the notification control processing). On the other hand, in the case of being determined that flicker has been detected (YES in the step S102), in steps S103 to S105, the flicker reduction processing determination unit 114 (the selecting unit) determines the effectiveness of each flicker reduction processing means (each flicker reduction processing method) based on at least one piece of information of the frequency, the phase, and the waveform.

In the step S103, the flicker reduction processing determination unit 114 determines the effectiveness of the flicker reduction processing method based on photographing timing (performs the processing for determining the effectiveness of the flicker reduction processing method based on photographing timing). In addition, in the step S104, the flicker reduction processing determination unit 114 determines the effectiveness of the flicker reduction processing method based on accumulation time (performs the processing for determining the effectiveness of the flicker reduction processing method based on accumulation time). Furthermore, in the step S105, the flicker reduction processing determination unit 114 determines the effectiveness of the flicker reduction processing method based on image correction gain (performs the processing for determining the effectiveness of the flicker reduction processing method based on image correction gain). After the determinations in the steps S103 to S105 are completed, the entire processing proceeds to the step S106, where the notification control processing is performed in accordance with the determination results, and the flicker notifying unit 115 notifies the user of an effective flicker reduction processing means (an effective flicker reduction processing method).

Thereafter, in a step S107, it is determined whether or not there is an effective flicker reduction processing method. In the case of being determined that there is an effective flicker reduction processing method (YES in the step S107), the entire processing proceeds to a step S108, where the flickerless photographing is performed, and then the entire processing ends. On the other hand, in the case of being determined that there is no effective flicker reduction processing method (NO in the step S107), the entire processing proceeds to a step S109, where normal photographing is performed, and then the entire processing ends.

FIG. 4A is the flowchart of the processing for determining the effectiveness of the flicker reduction processing method based on photographing timing, which is performed in the step S103 shown in FIG. 3.

As shown in FIG. 4A, first, in a step S201, it is determined whether or not it is still image photographing. In the case of being determined that it is still image photographing (YES in the step S201), since the photographing timing is capable of being freely controlled, the processing proceeds to a step S202. On the other hand, in the case of being determined that it is moving image photographing (NO in the step S201), since moving image photographing depends on a set rate, the processing proceeds to a step S206, where it is determined that the flicker reduction processing method based on photographing timing is not effective, and then the processing of FIG. 4A ends.

In the step S202, it is determined whether or not the flicker frequency has been detected by the flicker detecting unit 113. In the case of being determined that the flicker frequency has been detected by the flicker detecting unit 113 (YES in the step S202), the processing proceeds to a step S203. On the other hand, in the case of being determined that the flicker frequency has not been detected by the flicker detecting unit 113 (NO in the step S202), since the photographing timing is not capable of being adjusted, the processing proceeds to the step S206, where it is determined that the flicker reduction processing method based on photographing timing is not effective, and then the processing of FIG. 4A ends.

In the step S203, it is determined whether or not the phase of the flicker has been detected by the flicker detecting unit 113. In the case of being determined that the phase of the flicker has not been detected by the flicker detecting unit 113 (NO in the step S203), since the photographing timing is not capable of being adjusted, the processing proceeds to the step S206, where it is determined that the flicker reduction processing method based on photographing timing is not effective, and then the processing of FIG. 4A ends. On the other hand, in the case of being determined that the phase of the flicker has been detected by the flicker detecting unit 113 (YES in the step S203), the processing proceeds to a step S204.

In the step S204, it is determined whether or not the detected flicker frequency is equal to or less than a threshold value. It is conceivable that the threshold value may be, for example, a time it takes for each pixel from the upper part of the image pickup device 103 to the lower part of the image pickup device 103 to start accumulation (hereinafter, referred to as “a curtain speed”). This is because in the case where “one cycle time of the flicker is equal to or less than the curtain speed”, even if the barycenter of the accumulation of the image is adjusted to the timing at which the flickering light source is at its brightest, luminance unevenness and stripes will occur due to the influence of the flicker. In the case of being determined that the detected flicker frequency is equal to or less than the threshold value (YES in the step S204), the processing proceeds to a step S205, where it is determined that the flicker reduction processing method based on photographing timing is effective, and then the processing of FIG. 4A ends. On the other hand, in the case of being determined that the detected flicker frequency is greater than the threshold value (NO in the step S204), the processing proceeds to the step S206, where it is determined that the flicker reduction processing method based on photographing timing is not effective, and then the processing of FIG. 4A ends.

FIG. 4B is the flowchart of the processing for determining the effectiveness of the flicker reduction processing method based on accumulation time (Tv), which is performed in the step S104 shown in FIG. 3.

As shown in FIG. 4B, first, a step S211 is similar to the step S202 in FIG. 4A, and therefore its description will be omitted. In the case of being determined that the flicker frequency has been detected by the flicker detecting unit 113 (YES in the step S211), the processing proceeds to a step S212. On the other hand, in the case of being determined that the flicker frequency has not been detected by the flicker detecting unit 113 (NO in the step S211), the processing proceeds to a step S215, where it is determined that the flicker reduction processing method based on accumulation time is not effective, and then the processing of FIG. 4B ends.

In the step S212, it is determined whether it is a mode in which an accumulation time (Tv) is decided by the camera 100, that is, by the camera control unit 107, or a mode in which Tv is set by the user. In the case of being determined that it is the mode in which Tv is decided by the camera 100 (YES in the step S212), the processing proceeds to a step S214, where it is determined that the flicker reduction processing method based on accumulation time is effective, and then the processing of FIG. 4B ends. In this case, this is because Tv is set by the camera control unit 107 to an integer multiple of a reciprocal of the detected flicker frequency (an integer multiple of the flicker period). On the other hand, in the case of being determined that it is the mode in which Tv is set by the user (NO in the step S212), the processing proceeds to a step S213.

In the step S213, it is determined whether or not Tv set by the user is an integer multiple of the detected flicker period. In the case of being determined that Tv set by the user is an integer multiple of the detected flicker period (YES in the step S213), the processing proceeds to the step S214, where it is determined that the flicker reduction processing method based on accumulation time is effective, and then the processing of FIG. 4B ends. On the other hand, in the case of being determined that Tv set by the user is not an integer multiple of the detected flicker period (NO in the step S213), the processing proceeds to the step S215, where it is determined that the flicker reduction processing method based on accumulation time is not effective, and then the processing of FIG. 4B ends.

It should be noted that in the case of being determined in the step S212 that it is the mode in which Tv is set by the user, the flicker reduction function may be prioritized, and the mode may be changed to the mode in which Tv is decided by the camera control unit 107. In this case, after the mode is changed, the processing proceeds to the step S214.

FIG. 4C is the flowchart of the processing for determining the effectiveness of the flicker reduction processing method based on image correction gain, which is performed in the step S105 shown in FIG. 3.

As shown in FIG. 4C, first, a step S221 is similar to the step S202 in FIG. 4A, and therefore its description will be omitted. In the case of being determined that the flicker frequency has been detected by the flicker detecting unit 113 (YES in the step S221), the processing proceeds to a step S222. On the other hand, in the case of being determined that the flicker frequency has not been detected by the flicker detecting unit 113 (NO in the step S221), the processing proceeds to a step S224, where it is determined that the flicker reduction processing method based on image correction gain is not effective, and then the processing of FIG. 4C ends.

In the step S222, it is determined whether or not a condition that a photographing cycle of an image for correction gain calculation is an integer multiple of the reciprocal of the detected flicker frequency (an integer multiple of the flicker period) is met. For example, in the case where the image for correction gain calculation is a live view image with a photographing cycle of 30 fps with respect to a flicker frequency of 120 Hz, the flicker period becomes an integer multiple of the photographing cycle of the image for correction gain calculation. In this case, even if stripes and luminance unevenness due to the influence of the flicker occur, they will remain in the same position on the screen. For this reason, it is not possible to generate an image, which is not affected by the flicker, by applying a circular low-pass filter, and it is not possible to correctly calculate the correction value. Therefore, in the case of being determined that the above-described condition is not met (NO in the step S222), since the correction value is capable of being calculated, the processing proceeds to a step S223, where it is determined that the flicker reduction processing method based on image correction gain is effective, and then the processing of FIG. 4C ends. On the other hand, in the case of being determined that the above-described condition is met (YES in the step S222), since the correction value is not capable of being calculated, the processing proceeds to the step S224, where it is determined that the flicker reduction processing method based on image correction gain is not effective, and then the processing of FIG. 4C ends.

Next, the notification control processing performed in the step S106 shown in FIG. 3 and an example of a notification display based on the notification control processing will be described with reference to FIG. 5A, FIG. 5B, and FIG. 6.

FIG. 5A is a flowchart of the notification control processing performed in the step S106 shown in FIG. 3 according to the first embodiment.

As shown in FIG. 5A, first, in a step S301, it is determined whether or not flicker has been detected in the step S102 of FIG. 3. In the case of being determined that flicker has not been detected in the step S102 of FIG. 3 (NO in the step S301), the notification control processing proceeds to a step S306, where all of three icons shown in FIG. 6 corresponding to the respective flicker reduction processing methods are lighted out (turned off). On the other hand, in the case of being determined that flicker has been detected in the step S102 of FIG. 3 (YES in the step S301), the notification control processing proceeds to a step S302, where it is determined whether or not a setting that the user himself/herself selects a reduction method is enabled.

In the case of being determined that the setting that the user himself/herself selects a reduction method is enabled (YES in the step S302), the notification control processing proceeds to a step S303. On the other hand, in the case of being determined that the setting that the user himself/herself selects a reduction method is not enabled (NO in the step S302), the notification control processing proceeds to a step S302a.

In the step S303, out of the three icons shown in FIG. 6, all of the icons corresponding to the flicker reduction processing methods that have been determined to be effective in the processing of FIGS. 4A to 4C are lighted up (turned on) as icons corresponding to available reduction methods (a first notification control method).

In the step S302a, it is determined whether or not a setting that the camera 100 (the camera control unit 107) automatically selects a reduction method is enabled.

In the case of being determined that the setting that the camera 100 automatically selects a reduction method is enabled (YES in the step S302a), the notification control processing proceeds to a step S304. On the other hand, in the case of being determined that the setting that the camera 100 automatically selects a reduction method is not enabled (NO in the step S302a), the notification control processing proceeds to the step S109, where normal photographing is performed.

In the step S304, a processing for determining a reduction method with the highest priority (a reduction method priority determination processing) is executed (a determining unit). The reduction method priority determination processing will be described with reference to FIG. 5B. Thereafter, the notification control processing proceeds to a step S305, where the icon corresponding to the reduction method with the highest priority that has been determined in the process of the step S304, out of the three icons shown in FIG. 6, is lighted up (turned on) (a second notification control method). At this time, for example, in the case where a “gain” icon is lighted up, the gain amount at this time is set on the camera 100 side (by the camera control unit 107). Similarly, also in the case where a “timing” icon or an “accum” icon is lighted up, an appropriate timing or an appropriate accumulation time is set on the camera 100 side (by the camera control unit 107).

FIG. 5B is the flowchart of the reduction method priority determination processing performed in the step S304 shown in FIG. 5A. Here, the reduction method with the highest priority refers to a reduction method with the highest effectiveness in reducing the influence of flicker (a reduction method that is most effective in reducing the influence of flicker).

As shown in FIG. 5B, first, in a step S311, it is determined whether it is the mode in which Tv is set by the user, or a mode in which Tv is decided by the camera 100 (the accumulation time calculating unit 110). In the case of being determined that it is the mode in which Tv is set by the user (YES in the step S311), unlike the mode in which Tv is decided by the camera 100 (the accumulation time calculating unit 110), the accumulation time is not capable of being adjusted with respect to the detected flicker frequency by the camera 100 (the accumulation time calculating unit 110). Therefore, in order to decide either the flicker reduction processing method based on photographing timing or the flicker reduction processing method based on image correction gain to be the reduction method with the highest priority, the reduction method priority determination processing proceeds to a step S314. On the other hand, in the case of being determined that it is the mode in which Tv is decided by the camera 100 (the accumulation time calculating unit 110) (NO in the step S311), the reduction method priority determination processing proceeds to a step S312.

In the step S314, it is determined whether or not an ISO sensitivity used for photographing is a high ISO sensitivity equal to or higher than a certain predetermined value. In the case of being determined that the ISO sensitivity used for photographing is a high ISO sensitivity equal to or higher than the predetermined value (YES in the step S314), since there is a concern about the image quality when an image correction gain is applied in a later stage, the reduction method priority determination processing proceeds to a step S315, where the flicker reduction processing method based on photographing timing is decided to be the reduction method with the highest priority, and then the reduction method priority determination processing ends. On the other hand, in the case of being determined that the ISO sensitivity used for photographing is an ISO sensitivity less than the predetermined value (NO in the step S314), since there is no concern that a restriction on a frame rate, a release time lag, and the like will occur, the reduction method priority determination processing proceeds to a step S316, where the flicker reduction processing method based on image correction gain is decided to be the reduction method with the highest priority. After that, the reduction method priority determination processing ends.

In the step S312, it is determined whether or not a photographing subject is a moving subject. This determination is made, for example, by detecting a change in the position of the photographing subject in successive photographed images. In the case of being determined that the photographing subject is a moving subject (YES in the step S312), the reduction method priority determination processing proceeds to a step S313. On the other hand, in the case of being determined that the photographing subject is not a moving subject (NO in the step S312), the reduction method priority determination processing proceeds to a step S317, where the flicker reduction processing method based on accumulation time is decided to be the reduction method with the highest priority, and then the reduction method priority determination processing ends.

In the step S313, since in order to photograph a moving subject without subject blurring, it is desirable to perform photographing with a relatively fast accumulation time (a relatively short accumulation time), it is determined whether or not the flicker period (=a minimum accumulation time required to eliminate the flicker), which is the reciprocal of the frequency of the flicker, is equal to or longer than a predetermined time. In the case of being determined that the flicker period is shorter than the predetermined time (NO in the step S313), since the flicker reduction processing method based on accumulation time is capable of handling photographing of a moving subject, the reduction method priority determination processing proceeds to the step S317, where the flicker reduction processing method based on accumulation time is decided to be the reduction method with the highest priority, and then the reduction method priority determination processing ends. On the other hand, in the case of being determined that the flicker period is equal to or longer than the predetermined time (YES in the step S313), since the flicker reduction processing method based on accumulation time causes subject blurring of a moving subject during photographing, the reduction method priority determination processing proceeds to the step S314. The subsequent processing is as described above and the description thereof will be omitted.

As described above, according to the reduction method priority determination processing, an optimal means (an optimal method) in accordance with to the photographing environment is selected from among a plurality of flicker reduction processing means (a plurality of flicker reduction processing methods).

FIG. 6 is a conceptual diagram that illustrates an example of icon display performed by the flicker notifying unit 115 in the step S303 shown in FIG. 5A.

As shown in FIG. 6, the flicker notifying unit 115 causes to display three icons labeled “accum”, “timing”, and “gain” vertically arranged from the top in the upper right portion of the liquid crystal screen of the display unit 117. The three icons are icons corresponding to the respective flicker reduction processing means (the respective flicker reduction processing methods).

The icon labeled “accum” is an icon corresponding to the flicker reduction processing method based on accumulation time, and the icon labeled “timing” is an icon corresponding to the flicker reduction processing method based on photographing timing. In addition, the icon labeled “gain” is an icon corresponding to the flicker reduction processing method based on image correction gain.

In the example of FIG. 6, only the icon labeled “accum” is lighted out (turned off), and the icon labeled “timing” and the icon labeled “gain” are lighted up (turned on). In other words, this example is an example in which the user is notified that the flicker reduction processing method based on accumulation time is not effective, but the flicker reduction processing method based on photographing timing and the flicker reduction processing method based on image correction gain are effective.

As described above, according to the first embodiment, when a flickering light source is present in the photographing environment, the user is able to determine what flicker reduction processing means (what flicker reduction processing method) should be used for photographing to obtain a flicker reduction effect. For example, in the case where a moving subject is being photographed in a 100 Hz flicker environment, when Tv is set to 1/1000 by the user, the icon display shown in FIG. 6 is performed by the processing that have been shown in the flowcharts of FIGS. 3 to 5B. Therefore, the user is able to see that available flicker reduction processing means (available flicker reduction processing methods) are two options: the flicker reduction processing means based on photographing timing (the flicker reduction processing method based on photographing timing), and the flicker reduction processing means based on image correction gain (the flicker reduction processing method based on image correction gain). Therefore, if the user does not want to apply an image correction gain, he or she is able to select the flicker reduction processing method based on photographing timing, and if the user wants to give top priority to a frame rate of continuous photographing, he or she is able to select the flicker reduction processing method based on image correction gain. In this way, the content of the notification by the flicker notifying unit 115 is capable of being used as auxiliary information for the user to select a flicker reduction processing means (a flicker reduction processing method) according to his/her own priority.

It should be noted that in the first embodiment, the case where the camera 100 has three types of flicker reduction processing means (three types of flicker reduction processing methods) has been described, but the camera 100 may have another type of flicker reduction processing means (another type of flicker reduction processing method). In this case, a determination processing in accordance with the another type of flicker reduction processing method is performed, and an icon whose lighting up or lighting out is controlled by the flicker notifying unit 115 in accordance with the determination result of the determination processing is provided on the display unit 117. Here, the another type of flicker reduction processing means (the another type of flicker reduction processing method) may be, for example, a means (a method) in which in the case where in an image photographed under a high-frequency flickering light source, out of 4000 vertical pixels of the image, flickering stripes appear every 10 pixels, a low-pass filter is applied to attenuate the flickering of the stripes.

In addition, in the first embodiment, an example has been described in which the user is notified of the effective flicker reduction processing means by controlling lighting up and lighting out of the icons corresponding to the respective flicker reduction processing means, but the present disclosure is not limited to this example as long as a notifying means (the notifying unit) allows the user to distinguish the effective flicker reduction processing means. For example, the color of the corresponding icon may be changed depending on whether the flicker reduction processing means is effective or not.

Furthermore, in the first embodiment, although an example has been shown in which the icons representing the respective flicker reduction processing means are provided on the display unit 117, instead of the icons, the light source information (such as the frequency) of the flickering light source detected by the flicker detecting unit 113 may be displayed.

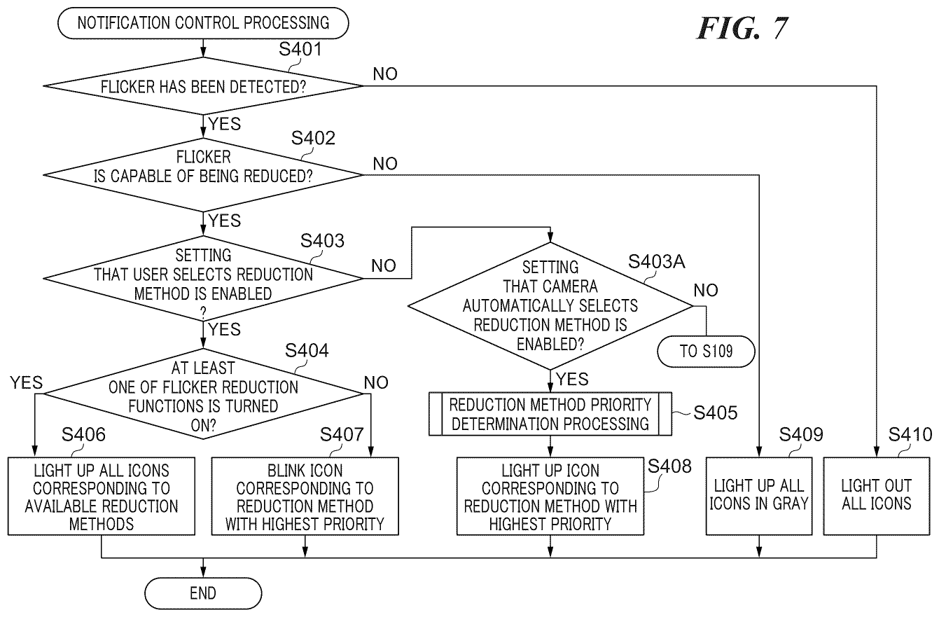

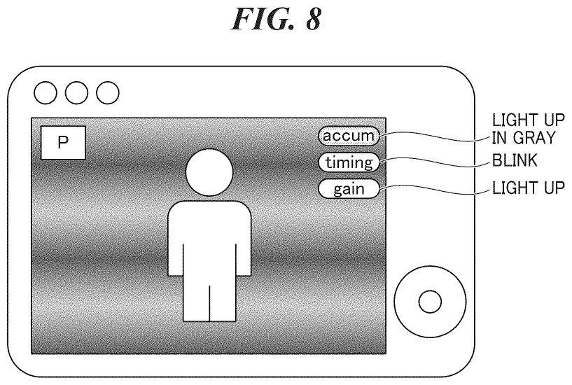

A second embodiment will be described. Hereinafter, a notification control processing according to the second embodiment and an example of icon display performed by the flicker notifying unit 115 will be described with reference to FIG. 7 and FIG. 8.

The second embodiment has a hardware configuration similar to the hardware configuration of the first embodiment, and the processing that have been described by using the flowcharts of FIG. 3 and FIGS. 4A to 4C are common to the first embodiment, so that the description thereof will be omitted.

FIG. 7 is a flowchart of the notification control processing performed in the step S106 shown in FIG. 3 according to the second embodiment.

As shown in FIG. 7, first, in a step S401, it is determined whether or not flicker has been detected in the step S102 of FIG. 3.

In the case of being determined that flicker has not been detected in the step S102 of FIG. 3 (NO in the step S401), the notification control processing proceeds to a step S410, where all of three icons shown in FIG. 8 corresponding to the respective flicker reduction processing methods are lighted out (turned off), and then the notification control processing ends.

On the other hand, in the case of being determined that flicker has been detected in the step S102 of FIG. 3 (YES in the step S401), the notification control processing proceeds to a step S402, where it is determined whether or not the flicker is capable of being reduced. Here, based on the respective determination results of the respective processing that are performed in the steps S103 to S105 shown in FIGS. 4A to 4C, it is determined which of the three flicker reduction processing means (which of the three flicker reduction processing methods) is effective, and in the case of being determined that there is even one effective flicker reduction processing means (there is even one effective flicker reduction processing method), it is determined that the flicker is capable of being reduced. On the other hand, in the case of being determined that there is not even one effective flicker reduction processing means (there is not even one effective flicker reduction processing method), it is determined that the flicker is not capable of being reduced.

In the case of being determined that the flicker is capable of being reduced (YES in the step S402), the notification control processing proceeds to a step S403. On the other hand, in the case of being determined that the flicker is not capable of being reduced (NO in the step S402), the notification control processing proceeds to a step S409, where all of the three icons shown in FIG. 8 corresponding to the respective flicker reduction processing methods are lighted up in gray (grayed out), and then the notification control processing ends.

The step S403 and a step S403a are similar to the steps S302 and S302a, respectively, and therefore their description will be omitted. It should be noted that in the case of YES in the step S403, the notification control processing proceeds to a step S404, and in the case of YES in the step S403a, the notification control processing proceeds to a step S405.

In the step S404, it is determined whether or not at least one of flicker reduction functions that respectively execute the three flicker reduction processing means (the three flicker reduction processing methods) has already been turned on by the user (has been selected by the user). In the case of being determined that at least one of the flicker reduction functions has been turned on by the user (YES in the step S404), the notification control processing proceeds to a step S406. On the other hand, in the case of being determined that none of the flicker reduction functions have been turned on by the user (NO in the step S404), the notification control processing proceeds to a step S407.

In the step S406, the flicker reduction function that is determined to be effective in the processing of FIGS. 4A to 4C and that is determined to have been turned on by the user in the step S404 is determined to be an optimal function, and the corresponding icon is lighted up (a fourth notification control method). In addition, for the flicker reduction function that is determined to be effective in the processing of FIGS. 4A to 4C and that is determined to have not been turned on by the user in the step S404, the corresponding icon is caused to blink as a warning display to the user (a third notification control method). On the other hand, in the case of the flicker reduction function that is determined to be ineffective in the processing of FIGS. 4A to 4C, regardless of the result of the determination in the step S404, in order to notify the user that the flicker reduction function is not effective, the icon corresponding to the flicker reduction processing means (the flicker reduction processing method) is lighted up in gray (grayed out) (a fifth notification control method). After that, the notification control processing ends.

In the step S407, the reduction method priority determination processing of the step S304 is performed, and the icon corresponding to the reduction method with the highest priority that has been determined in the reduction method priority determination processing of the step S304 is caused to blink, and then the notification control processing ends.

The step S405 and a step S408 are similar to the steps S304 and S305, respectively, and therefore their description will be omitted.

FIG. 8 is a conceptual diagram that illustrates an example of icon display performed by the flicker notifying unit 115 in the step S406 shown in FIG. 7.

As shown in FIG. 8, in the same manner as in FIG. 6, the flicker notifying unit 115 causes to display three icons labeled “accum”, “timing”, and “gain” vertically arranged from the top in the upper right portion of the liquid crystal screen of the display unit 117. These three icons are the same as the three icons with similar labels in FIG. 6, respectively, and therefore the descriptions thereof will be omitted.

In the example of FIG. 8, the icon labeled “accum” is lighted up in gray (grayed out), the icon labeled “timing” is blinking, and the icon labeled “gain” is lighted up (turned on). An example of such icon display in the notification control processing of FIG. 7 is a case where a moving subject is being photographed in a 100 Hz flicker environment, the accumulation time (Tv) has been set to 1/1000 by the user, and out of the three flicker reduction functions, only the flicker reduction function based on image correction gain has been turned on by the user. In the case of this example, since the accumulation time has been set by the user to 1/1000, which is shorter than the flicker frequency, and since it is determined in the step S104 that the flicker reduction processing means based on accumulation time (the flicker reduction processing method based on accumulation time) is not effective, the icon labeled “accum” is lighted up in gray (grayed out). It should be noted that for the flicker reduction function corresponding to the flicker reduction processing means (the flicker reduction processing method) that has been determined to be ineffective in the steps S103 to S105, regardless of whether the flicker reduction function has been set by the user to be turned on or off, the flicker reduction function is turned off and the corresponding icon is lighted up in gray (grayed out). In addition, although it is determined in the step S103 that the flicker reduction processing means based on photographing timing (the flicker reduction processing method based on photographing timing) is effective, since the flicker reduction function based on photographing timing has not been set by the user to be turned on, the icon labeled “timing” has become blinking display, which also serves as a warning. On the other hand, since it is determined in the step S105 that the flicker reduction processing means based on image correction gain (the flicker reduction processing method based on image correction gain) is effective, and since the flicker reduction function based on image correction gain has been set by the user to be turned on, the icon labeled “gain” has become lighting up display, which indicates that it is optimal.

As described above, in order to indicate the statuses of the three flicker reduction functions, in the first embodiment, the corresponding icon is either lighted up (turned on) or lighted out (turned off), and on the other hand, in the second embodiment, the corresponding icon is either lighted up (turned on), lighted out (turned off), blinked, or lighted up in gray (grayed out).

As a result, it is possible to understand the situation taking into account the photographing environment and current camera settings, such as whether the flicker has not been detected, whether the flicker reduction function has not been enabled, or whether there is no photographing method capable of reducing flicker in the first place. This makes it possible to more clearly indicate the operations that should be performed in order to perform photographing intended by the user.

According to the present disclosure, it is possible to notify the user of the photographing method in which the flickerless photographing is effective.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-131924, filed Aug. 8, 2024, which is hereby incorporated by reference herein in its entirety.

What is claimed is:

1. An image pickup apparatus comprising:
an image pickup unit configured to pick up an image of a subject and obtain image signals; and
at least one processor and/or circuit configured to function as:
a detecting unit that detects light source information of a light source at a time of image pickup from the image signals;
a selecting unit that, in a case where the light source at the time of image pickup is a flickering light source, selects an effective reduction processing method for reducing an influence of the flickering light source from among a plurality of flicker reduction processing methods based on the detected light source information; and
a notifying unit that notifies a user of the selected reduction processing method.

2. The image pickup apparatus according to claim 1, wherein
in the case where the light source at the time of image pickup is the flickering light source, the light source information includes at least one of a period, a phase, and a waveform of a change in brightness of the flickering light source.

3. The image pickup apparatus according to claim 1, wherein
the at least one processor and/or circuit is configured to further function as a timing calculating unit that calculates a photographing timing, which is capable of reducing the influence of the flickering light source, from the light source information, and
the plurality of flicker reduction processing methods includes a processing of performing image pickup control at the calculated photographing timing.

4. The image pickup apparatus according to claim 1, wherein
the at least one processor and/or circuit is configured to further function as an accumulation time calculating unit that calculates an accumulation time, which is capable of reducing the influence of the flickering light source, from the light source information, and
the plurality of flicker reduction processing methods includes a processing of performing image pickup control by using the calculated accumulation time.

5. The image pickup apparatus according to claim 1, wherein
the at least one processor and/or circuit is configured to further function as a correction calculating unit that calculates an image correction gain, which is capable of reducing the influence of the flickering light source, from the light source information, and
the plurality of flicker reduction processing methods includes a processing of performing control of applying the calculated image correction gain to the image signals.

6. The image pickup apparatus according to claim 1, wherein
the notifying unit has a plurality of notification control methods.

7. The image pickup apparatus according to claim 6, wherein
the plurality of notification control methods includes a first notification control method that, in a case where at least one of the plurality of flicker reduction processing methods is selected by the user and image pickup is performed, notifies all of the reduction processing methods selected by the selecting unit.

8. The image pickup apparatus according to claim 6, wherein
the at least one processor and/or circuit is configured to further function as a determining unit that, in accordance with settings of the image pickup apparatus, determines the most effective reduction processing method for reducing the influence of the flickering light source from among the plurality of flicker reduction processing methods, and
the plurality of notification control methods includes a second notification control method that, in a case where image pickup is performed by using the reduction processing method determined by the determining unit, notifies the user of the reduction processing method determined by the determining unit.

9. The image pickup apparatus according to claim 8, wherein
the determining unit determines the most effective reduction processing method depending on whether an accumulation time is set by the user or an accumulation time capable of reducing the influence of the flickering light source is calculated from the light source information.

10. The image pickup apparatus according to claim 8, wherein
the determining unit determines the most effective reduction processing method depending on whether a photographing subject is a moving subject or not.

11. The image pickup apparatus according to claim 8, wherein
the determining unit determines the most effective reduction processing method depending on whether a period of a change in brightness of the flickering light source is equal to or longer than a predetermined time or not.

12. The image pickup apparatus according to claim 8, wherein
the determining unit determines the most effective reduction processing method depending on whether an ISO sensitivity used for photographing is equal to or higher than a predetermined value or not.

13. The image pickup apparatus according to claim 6, wherein
the plurality of notification control methods includes a third notification control method that, in a case where there is a reduction processing method selected in advance by the user as a reduction processing method to be used for image pickup among the plurality of flicker reduction processing methods, performs a warning display with respect to a reduction processing method that has been selected by the selecting unit as the effective reduction processing method and has not been selected by the user.

14. The image pickup apparatus according to claim 13, wherein
a fourth notification control method that, in a case where there is a reduction processing method that has been selected by the selecting unit as the effective reduction processing method and has been selected by the user, notifies the user that the reduction processing method is optimal is included.

15. The image pickup apparatus according to claim 13, wherein
a fifth notification control method that, in a case where there is a reduction processing method that has not been selected by the selecting unit as the effective reduction processing method, regardless of whether the user has selected the reduction processing method or not, notifies the user that the reduction processing method is not effective is included.

16. A control method for an image pickup apparatus, the control method comprising:
an image pickup step of picking up an image of a subject and obtaining image signals;
a detecting step of detecting light source information of a light source at a time of image pickup from the image signals;
a selecting step of, in a case where the light source at the time of image pickup is a flickering light source, selecting an effective reduction processing method for reducing an influence of the flickering light source from among a plurality of flicker reduction processing methods based on the detected light source information; and
a notifying step of notifying a user of the selected reduction processing method.

17. A non-transitory computer-readable storage medium storing a program for causing a computer to execute a control method for an image pickup apparatus, the control method comprising:
an image pickup step of picking up an image of a subject and obtaining image signals;
a detecting step of detecting light source information of a light source at a time of image pickup from the image signals;
a selecting step of, in a case where the light source at the time of image pickup is a flickering light source, selecting an effective reduction processing method for reducing an influence of the flickering light source from among a plurality of flicker reduction processing methods based on the detected light source information; and
a notifying step of notifying a user of the selected reduction processing method.
